(19) United States
(12) Patent Application Publication
(10) Pub. No.: US 2008/0065874 A1
(43) Pub. Date: Mar. 13, 2008

(54) SYSTEM AND METHOD FOR DYNAMIC DETERMINATION OF SYSTEM TOPOLOGY IN A MULTIPLE BUILDING BLOCK SERVER SYSTEM

(76) Inventors: Andrew Geissler, Pflugerville, TX (US); Andreas Bieswanger, Ehningen (DE); Gary Anderson, Austin, TX (US); Herwig Elfering, Offendorf (FR); Hye-Young McCreary, Liberty Hill, TX (US); Juergen Saalmueller, Boeblingen (DE); Kanisha Patel, Austin, TX (US)

Correspondence Address: JANIS E. CLEMENTS, 3112 LOMITA DRIVE, AUSTIN, TX, 78738, US

(21) Appl. No.: 11/470,700

(22) Filed: Sep. 7, 2006

(51) Int. Cl. G06F 15/177

(52) U.S. Cl. 713/1

(57) ABSTRACT

A system and method for an initial boot of a system before adding or removing drawers to a system without requiring an n-level cable. Standby power is applied after all cables have been connected to the system. All available expansion ports for an SMP cable are searched. A unique ID is sent over and received by all plugged SMP cables. A list of each controller and its connected controllers is created, and a master controller is assigned. A plugging table of each controller is sent to the master controller. The master controller compares all received plugging tables to plugging rules. Errors are reported in cable plugging errors and system configuration is reported to platform management service.

### TECHNICAL FIELD

The present invention relates to a system and method for concurrently adding a new drawer to a system. More particularly, the present invention relates to methods, apparatus, and products for an initial boot before adding or removing drawers to a system without requiring an n-level cable.

### BACKGROUND OF RELATED ART

One current server design comprises a system made up of smaller building blocks, referred to as “drawers.” Special cables are used to connect the coherency fabrics between the drawers to form a single symmetric multiprocessing (SMP) system. With the advent of the multi-drawer system, systems now have the capability to plug between 1 and n individual drawers which would contribute processors, memory, and I/O to a single system. This configuration requires each of the drawers to be a part of a single controlling entity needing a special n-level cable for each specific configuration. The n-level cable referred to herein is a fabric cable found on most large SMP server systems currently. The value n is constrained by the amount of drawers that fit within a single physical enclosure and the size of the n-level cable. These drawers are individual computing entities which can boot and provide required server functionality and can be interconnected so that a single cable type can be used to connect them.

Currently, when a user wishes to add or remove a drawer from a system, the user is required to have a specific SMP cable type for that configuration. For example, a two drawer system requires a special two drawer cable and a three drawer system requires a different three drawer cable. When a user wishes to add or remove a drawer, the user is required to unplug the old cable from all of the present drawers and plug in the new cable. The exchange of the n-level cable on current systems cannot be done concurrently. What is needed, therefore, is a method and system for dynamic determination of system topology in a multiple building block server system. Furthermore, there is a need for a method for users to add or remove a node without needing a new n level cable, a method for users to easily separate or combine the drawers they own into congruent computing entities, and a method to automatically determine system configuration, verify it, and present it to the user or customer.

### SUMMARY OF THE PRESENT INVENTION

The present invention provides a method and system for concurrently adding a new drawer to a system. More particularly, a method and system for an initial boot of a system before adding or removing drawers to a system without requiring an n-level cable are described herein. One embodiment comprises a method wherein standby power is applied after all cables have been connected to the system. All available expansion ports for an SMP cable are searched. A unique ID is sent over and received by all plugged SMP cables. A list of each controller and its connected controllers is created, and a master controller is assigned. A plugging table of each controller is sent to the master controller. The master controller compares all received plugging tables to plugging rules. Errors are reported in cable plugging errors and system configuration is reported to platform management service.

The present invention provides a method for a user to easily plug and play different computing entities that result in a configuration desired by the user. This is achieved with a combination of special cable sensing technology and firmware. A user is allowed to ship only the new drawer and a standard SMP cable without sending a special “n-level” cable. The user simply connects the new drawer to the existing drawers with no concern about inter-connections of other drawers. Different cable length is supported depending on requirements of the user configuration. These systems are easily installed initially and can be extended simply by adding new drawers and connector cables. When adding a new drawer, there is no requirement to replace a previous SMP cable. Cable sensing technology combined with the cable walking algorithm of the present invention enable the system to automatically determine its system configuration, define a master controller, and verify that all cables are properly plugged in.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processor controlled system on which the present invention for concurrently adding a new drawer to a system may be practiced;

FIG. 2 is a block diagram of a cable system of the present invention;

FIG. 3 is a flowchart of the steps involved for drawer addition of the present invention; and

FIG. 4 is a flowchart of the steps involved for splitting a fabric routing table into two SMP complexes of the present invention.

### DETAILED DESCRIPTION OF THE PREFERRED EMBODIMENT

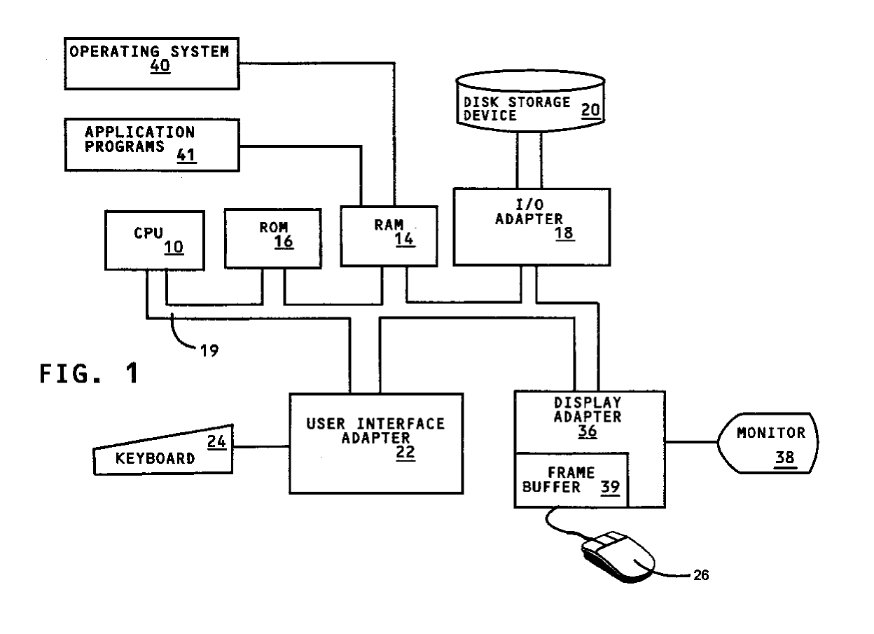

Referring to FIG. 1, a generalized system is shown which may function as a basic data processing system on which the present invention may be implemented. This system is an illustrative data processing system which can be used in any of the servers or computers in the preferred embodiment of the present invention. A CPU 10 is provided and interconnected to various other components by system bus 19. An operating system 40 may be connected to random access memory (RAM) 14 during the system operation. Operating system 40 may be one of the commercially available operating systems which is capable of handling single or multiprocessing, such as IBM's AIX™ operating system, Microsoft's Windows XP™ and UNIX™ operating systems. Application programs 41 controlled by the system can be moved into and out of the main memory, RAM 14. These application programs may include the programs for carrying out the present invention which will hereinafter be described in greater detail. It should be noted that the program logic and methods of the present invention may be implemented as software, firmware, hardware, or a combination thereof.

The system shown in FIG. 1 also includes the following conventional elements. A read only memory (ROM) 16 is connected to CPU 10 via system bus 19. RAM 14 and I/O adapter 18 are also interconnected to system bus 19. I/O adapter 18 may be a small computer system interface (SCSI) adapter that communicates with the disk storage device 20. I/O devices are also connected to system bus 19 via user interface adapter 22 and display adapter 36. Keyboard 24 and mouse 26 are all interconnected to bus 19 through user interface adapter 22. It is through such input devices that the user may interact with a browser and the related programs according to the present invention. Display adapter 36 includes a frame buffer 39, which is a storage device that holds a representation of each pixel on the display screen of the monitor 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display monitor 38.

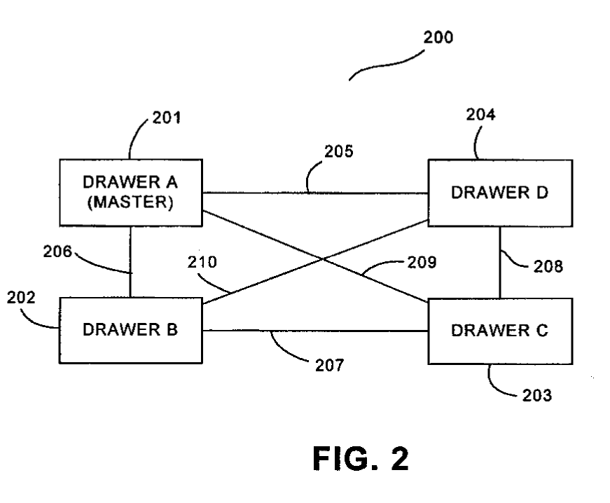

In FIG. 2, there is illustrated a cable system for adding a new drawer to a system having multiple drawers 200. In FIG. 2, Drawer A 201 is selected as a master drawer. Drawers A 201, B 202, and C 203 are drawers in an initial configuration. Drawer D 204 is a new drawer being added to the initial configuration in FIG. 2. New Drawer D 204 is brought into a standby state. Drawer A 201 is connected with Drawer D 204 via a cable 205. Symmetric processing (SMP) cables 205, 206, 207, 208, 209, and 210 connect the drawers according to plugging rules. In FIG. 2, Drawer A 201 connects with Drawer C via cable 209, and with Drawer B 202 via cable 206. Drawer B connects with Drawer D 204 via cable 210. Drawer C 203 connects with Drawer B 202 via cable 207, and with Drawer D 204 via cable 208. A plugging event is signaled to a new controller and existing controller on a remote of a connection or cable. In FIG. 2, when a drawer is connected with Drawer D 204, the new drawer is notified that a master drawer is already selected and the system is booted. Drawer D 204 is notified regarding amount of other drawers in the system and awaits all connections to appear.

Unique IDs of each controller are sent to each other, and plugging tables of each controller are updated. Plugging tables are sent to a master controller. Verification is made through the master controller that all cables are connected according to plugging rules. Once all connections are verified, the master Drawer A 201 is notified and it requests that Drawer D 204 initialize its chips. Once Drawer D 204 is ready, a fabric sync is executed and resources for Drawer D 204 are reported to a hypervisor. Errors are reported appropriately in case of cable plugging errors, and the system configuration is reported to a platform management service. In FIG. 2, the hypervisor then reports new resources to the system console for customer allocation.

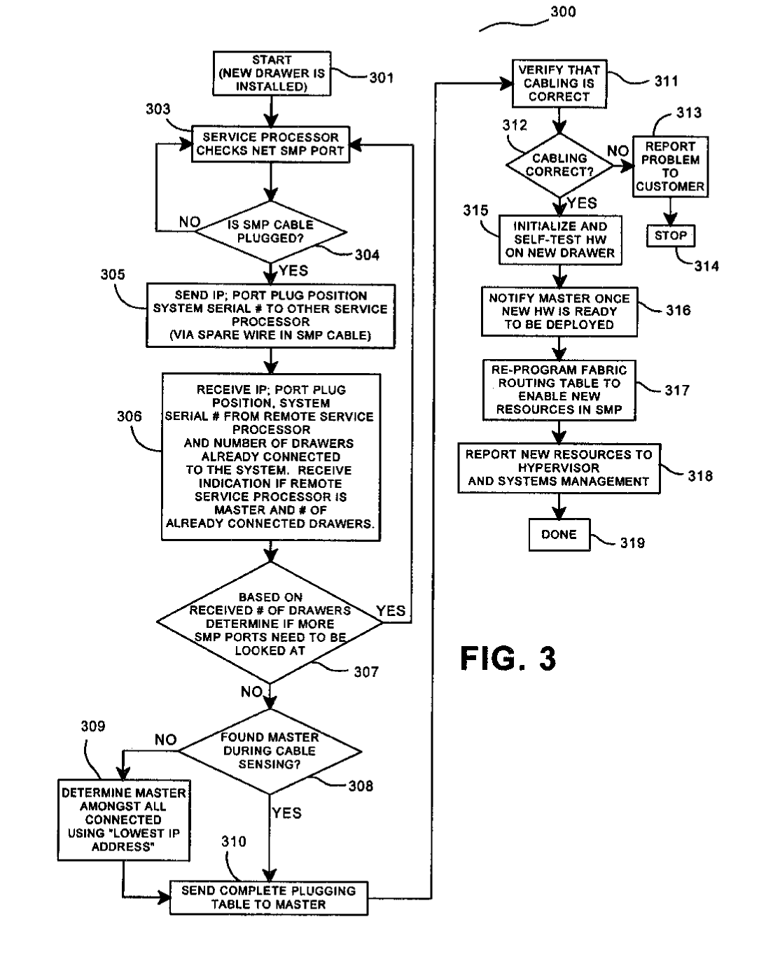

FIG. 3 is an embodiment of the present invention showing a flowchart of the steps involved for drawer addition 300. First, the process begins when a new drawer is installed, step 301. Standby power is applied after all cables have been connected to the system. All available expansion ports are searched for a symmetric multiprocessing (SMP) cable. A service processor checks a next SMP port, step 303. A determination is made regarding whether an SMP cable is plugged in, step 304. If No, the process returns to step 303 and the service processor checks the next SMP port. If Yes, information, such as a unique ID, is sent to other service processor, including IP, port plug position, and system serial number, via a spare wire in the SMP cable, step 305. This information or unique ID is received from remote service processor as well as information regarding number of drawers already connected to the system, and an indication of whether remote service processor is master and number of already connected drawers, step 306. A determination is made regarding whether more SMP ports need to be inspected based on received number of drawers, step 307. If Yes, the process of the service processor checking the next SMP port repeats, beginning with step 303.

A master controller is assigned, and a plugging table is sent of each controller to the master controller. As shown in FIG. 3, if No, a determination is made regarding whether a master cable is found during cable sensing, step 308. If No, the master is determined amongst all connected cables using lowest IP address method, step 309, then a complete plugging table is sent to the master, step 310. If Yes, step 309 is skipped and the process continues to step 310 of sending a complete plugging table to the master, step 310. Then verification is made that cabling is correct, step 311. A determination is made regarding whether cabling is correct, step 312. If No, the problem is reported to the customer, step 313, and the process ends, step 314. If Yes, hardware is initialized and self-tested on the new drawer, step 315, and the master is notified once the new hardware is ready to be deployed, step 316. A fabric routing table is re-programmed to enable new resources in SMP, step 317. Errors are reported appropriately in case of cable plugging errors, and the system configuration is reported to a platform management service. New resources are reported to the hypervisor and systems management, step 318, and the process is completed, step 319. It is understood that dynamic removal of a controller is also supported by an embodiment of the present invention.

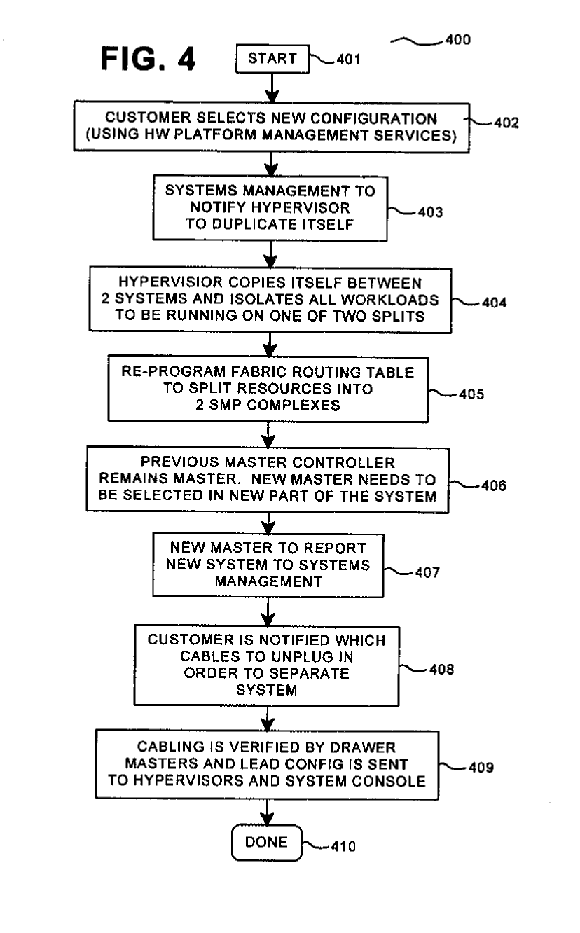

FIG. 4 shows a flowchart of the steps involved for splitting a fabric routing table into two SMP complexes 400. The process begins, step 401, and a customer selects a new configuration using hardware platform management services, step 402. Systems management notifies hypervisor to duplicate itself, step 403. Hypervisor copies itself between two systems and isolates all workloads to be running on one of two splits, step 404. Fabric routing table is re-programmed to split resources into two SMP complexes, step 405. Previous master controller remains master, and a new master is selected in a new part of the system, step 406. The new master reports the new system to Systems Management, step 407. The customer is notified regarding which cables to unplug in order to separate the system, step 408. Cabling is verified by drawer masters and valid configuration is sent to hypervisors and system console, step 409, and the process ends, step 410. In FIG. 4, the hypervisor detects which resources are assigned to which partitions and regulates them so that they remain equal to the resources in their initial configuration while they are divided across the system split. A user interface reports an error if a drawer attempting to be split cannot provide enough resources for its current partition.

One of the preferred implementations of the present invention is an application program 41 made up of programming steps or instructions resident in RAM 14, FIG. 1, during computer operations. Until required by the computer system, the program instructions may be stored in another readable medium, e.g. disk drive 20, or in a removable memory such as an optical disk for use in a CD ROM computer drive or in a floppy disk for use in a floppy disk drive computer input. One skilled in the art would appreciate that the processes controlling the present invention are capable of being distributed in the form of computer readable media of a variety of forms. The invention may be enabled also in firmware, hardware, or a combination of hardware and software. When the implementation of this invention involves a network, such as the Internet, the applications involved in this invention may be transmitted through the Internet via wired or appropriate wireless transmissions so that they may be downloaded at the computer controlled device using the applications.

Although certain preferred embodiments have been shown and described, it will be understood that many changes and modifications may be made therein without departing from the scope and intent of the appended claims.

1. A method for an initial boot before adding or removing drawers to a system without requiring an n-level cable, said method comprising:
applying standby power after all cables have been connected to the system;
searching all available expansion ports for a symmetric multiprocessing (SMP) cable;
sending a unique ID over all plugged SMP cables;
receiving a unique ID from said plugged SMP cables;
creating a list of each controller and its connected controllers;
assigning a master controller;
sending a plugging table of each controller to the master controller;
comparing by master controller all received plugging tables to plugging rules;
reporting errors appropriately in case of cable plugging errors; and
reporting system configuration to platform management service.

2. The method of claim 1 wherein comparing all received plugging tables is via one or more pins on the cable and one or more wires in the cable for communication.

3. The method of claim 2 wherein a controller in a drawer senses a plug event to the pin and communicates via the wires.

4. The method of claim 3, wherein the unique ID is based upon an IP address of the drawer.

5. The method of claim 3, wherein the unique ID is based upon a plug position of the cable used for communication.

6. The method of claim 3, wherein the unique ID is based upon a system serial number of the drawer.

7. The method of claim 3, further comprising dynamic removal of a controller.

8. A computer controlled system for concurrently adding a new drawer to a system, said system comprising:
bringing a new drawer into a standby state;
connecting a cable according to plugging rules;
signaling a plugging event to a new controller and existing controller on a remote of said cable;
sending unique IDs of each controller to each other;
updating plugging tables of each controller;
sending said plugging tables to a master controller;
verifying through said master controller that all cables are connected according to plugging rules;
reporting errors appropriately in case of cable plugging errors; and
reporting system configuration to platform management service.

9. The system of claim 8, wherein the cable is a symmetric processing (SMP) cable.

10. The system of claim 9, wherein unique ID information is sent to other service processor via a spare wire in SMP cable.

11. The system of claim 9, wherein the master controller is determined by using lowest IP address.

12. The system of claim 9, wherein verifying that all cables are connected via one or more pins on the cable and one or more wires in the cable for communication.

13. The system of claim 12 wherein a controller in a drawer senses a plug event to the pin and communicates via the wires.

14. The system of claim 10, wherein the unique ID is based upon an IP address of the drawer.

15. The system of claim 10, wherein the unique ID is based upon a plug position of the cable used for communication.

16. The system of claim 10, wherein the unique ID is based upon a system serial number of the drawer.

17. The system of claim 9, further comprising dynamic removal of a controller.

18. A computer program having code recorded on a computer readable medium for concurrently adding a new drawer to a system, said program comprising:
bringing a new drawer into a standby state;
connecting a symmetric processing (SMP) cable according to plugging rules;
signaling a plugging event to a new controller and existing controller on a remote of said cable;
sending unique IDs of each controller to each other;
updating plugging tables of each controller;
sending said plugging tables to a master controller;
verifying through said master controller that all cables are connected according to plugging rules;
reporting errors appropriately in case of cable plugging errors; and
reporting system configuration to platform management service.

19. The system of claim 17 wherein verifying that all cables are connected via one or more pins on the cable and one or more wires in the cable for communication.

20. The system of claim 18 wherein a controller in a drawer senses a plug event to the pin and communicates via the wires.
